(19) United States
(12) Patent Application Publication
(10) Pub. No.: US 2022/0246050 A1
(43) Pub. Date: Aug. 4, 2022

(54) AUTOCORRECTING DEVICE SUITABLE FOR LEARNING A RULE OF GRAMMAR IN A ROMANCE LANGUAGE

(71) Applicants: Maud Dombreval, Nieul-Les-Saints (FR); Peter Heppel, Port-Louis (FR)

(72) Inventors: Maud Dombreval, Nieul-Les-Saints (FR); Peter Heppel, Port-Louis (FR)

(21) Appl. No.: 17/629,536

(22) PCT Filed: Jul. 24, 2020
(86) PCT No.: PCT/FR2020/051361

§ 371 Date: Jan. 24, 2022

(30) Foreign Application Priority Data
Jul. 24, 2019 (FR) FR1908380

(51) Int. Cl. G09B 1/20; G09B 1/08; G09B 1/10; G09B 1/30

(52) U.S. Cl. CPC G09B 1/20; G09B 1/08; G09B 19/06; G09B 1/30; G09B 1/10

(57) ABSTRACT

Autocorrecting device comprising a support; at least two constant-diameter objects that can be rotated, at least one of the objects being referred to as determinant, the other at least one object being referred to as determined, each of the objects being provided with at least one stimulus associated with an angular position of the object; a drive means for driving the objects in rotation and having an object-driving torque M; a rotational blocking means for angularly blocking a determinant object in position; a selection means for selecting an angular position of a first object with respect to a second object, the selection means applying a resistive torque Cr between the first and second objects the two objects having a coupled position in which the resistive torque is higher than the driving torque M and an uncoupled position in which the resistive torque is lower than the driving torque M.

### CROSS-REFERENCE TO RELATED APPLICATIONS

This application is a national phase entry under 35 U.S.C. § 371 of International Patent Application PCT/FR2020/051361, filed Jul. 24, 2020, designating the United States of America and published as International Patent Publication WO 2021/014107 A1 on Jan. 28, 2021, which claims the benefit under Article 8 of the Patent Cooperation Treaty to French Patent Application Serial No. FR1908380, filed Jul. 24, 2019.

### TECHNICAL FIELD

The present disclosure relates to an autocorrecting device suitable, in particular, for learning a grammar rule in a Romance language. The present disclosure also relates to an autocorrecting method implementing the device according to the present disclosure.

### BACKGROUND

There are many devices for learning a grammar rule in a Romance language in electronic form. The user of the electronic device can learn the grammar rule in a fun way, for example, by making mistakes several times and starting over.

Nevertheless, electronic devices are not always suitable for children, and there are strong educational reasons for a manual readable device.

Moreover, there are educational movements that develop this thesis, such as the movement developed by the Montessori school, which considers that the purpose of educational material is to make the concept being taught concrete.

Moreover, electrical devices are not universally available or usable. In addition to being expensive and partly made from rare materials, they often require a power supply.

There is therefore a need to be able to offer the child an autocorrecting device, with understandable operation, which is suitable, in particular, for learning a grammar rule in a Romance language and which can be used in different places of learning, and, in particular, speech therapy practices, schools and the like.

### BRIEF SUMMARY

One aim of the present disclosure is, in particular, to address all or part of the aforementioned drawbacks.

According to a first aspect of the present disclosure, an autocorrecting device is proposed comprising:
a support,
at least two constant-diameter objects that can be rotated, at least one of the objects being referred to as determinant, the other at least one object being referred to as determined, each of the objects being provided with at least one stimulus associated with an angular position of the object,
a drive means for driving the objects in rotation, the drive means having a predetermined object-driving torque M,
a rotational blocking means for blocking a determinant object in a predetermined angular position,
a selection means for selecting an angular position of a first object with respect to a second object, the selection means applying a resistive torque Cr between the first object and the second object, the two objects having a relative angular position referred to as coupled position in which the resistive torque is greater than the driving torque M and a relative angular position referred to as uncoupled position in which the resistive torque is lower than the driving torque M.

According to a preferred embodiment, the objects are cylinders with a circular base, and the support is a base having a longitudinal direction, the support being provided with a groove formed along the longitudinal axis arranged to receive successively, removably and at least partially, along the longitudinal direction of the base, each of the cylinders when the generatrix of the cylinder is positioned parallel to the longitudinal direction of the base, the longitudinal groove being arranged to receive the cylinders mounted free in rotation, the drive means being driven in rotation by a crank.

According to one possibility, the means for selecting an angular position can have one or several coupled relative angular positions.

Advantageously, the device according to the first aspect of the present disclosure may comprise several selection means, positioned at different distances from an axis of rotation of the object.

The rotational blocking means for blocking a determinant object in a predetermined angular position may, for example, be formed by a peg and a notch.

The rotational blocking means for blocking a determinant object in a predetermined angular position may be formed by complementary magnetic means.

Alternatively, or in addition, the selection means for selecting an angular position is formed by magnetic means cooperating with one another.

According to a second aspect of the present disclosure, there is proposed an autocorrecting method, suitable for learning a Romance language, comprising a step of selecting an angular position of a first object relative to a second object by a selection means, the selection means applying a resistive torque Cr between the first object and the second object, the two objects having a relative angular position referred to as coupled position in which the resistive torque is higher than the driving torque M and a relative angular position referred to as uncoupled position in which the resistive torque is lower than the driving torque M.

### BRIEF DESCRIPTION OF THE DRAWINGS

Other advantages and particularities of the present disclosure will become apparent on reading the detailed description of implementations and embodiments, which are in no way limiting, with reference to the accompanying drawings, in which:

FIG. 1 is a perspective view of a preferred embodiment of an autocorrecting device according to the present disclosure;

FIG. 2 is a cross section of the embodiment of FIG. 1;

FIG. 3 is a perspective view of a second embodiment of an autocorrecting device according to the present disclosure;

FIG. 4 shows another embodiment of a means for selecting an angular position of a first object relative to a second object;

FIG. 5 is a perspective view of a third embodiment of an autocorrecting device according to the present disclosure.

This machine allows users, mainly children, to manipulate and experiment with sentence construction without the help of an adult. The autocorrecting nature of the machine allows autonomous and deductive use.

### DETAILED DESCRIPTION

Since the embodiments described hereinafter are not limiting in nature, it is possible, in particular, to consider variants of the present disclosure that comprise only a selection of the features that are described, provided that this selection of features is sufficient to confer a technical advantage or to differentiate the present disclosure from the prior art. This selection comprises at least one preferably functional feature without structural details, or with only a portion of the structural details if this portion alone is sufficient to confer a technical advantage or to differentiate the embodiments of the present disclosure from the prior art.

In the figures, an element appearing in a plurality of figures retains the same reference.

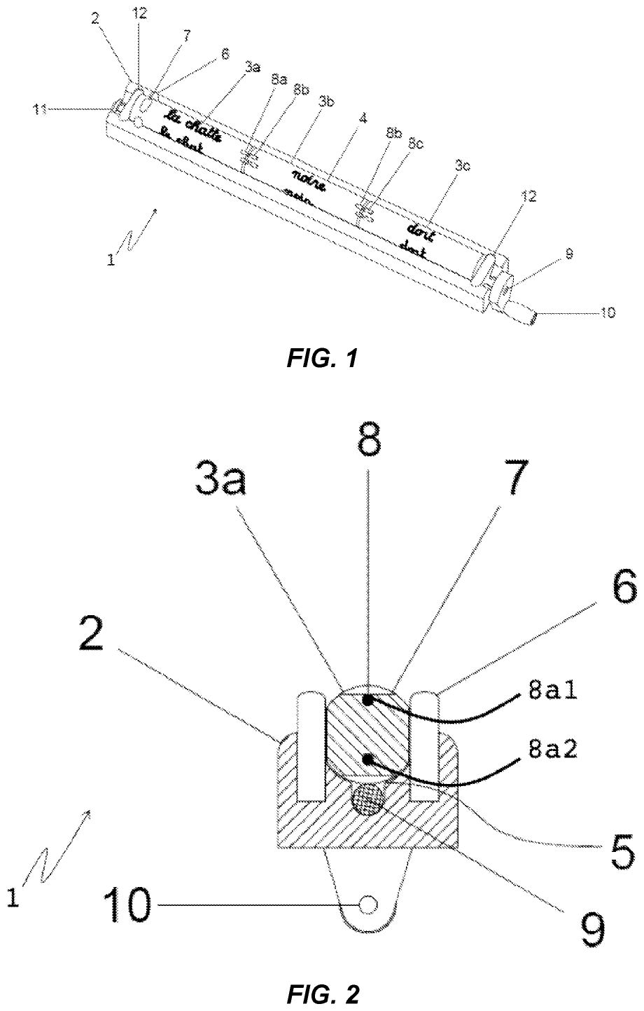

FIGS. 1 and 2 show a first embodiment of an autocorrecting device according to the present disclosure, particularly suitable for learning a grammar rule in a Romance language.

An autocorrecting method, suitable, in particular, for learning a grammar rule in a Romance language, according to the present disclosure is described at the same time as the autocorrecting device.

Different grammar rules can be learned, such as those describing agreements between subject, verb and adjectives or those relating to conjugation.

The device comprises a support, here a base 2 of generally cylindrical shape in a longitudinal direction.

The device comprises a plurality of objects that can be rotated, here three cylinders, or rollers, numbered 3a, 3b, 3c. Of course, the device could comprise two or more rollers.

The cylinders may be made of wood and/or may contain, or even be made of, any other sufficiently rigid material such as plastic, metal or ceramic.

Each of the rollers 3a, 3b, 3c is cylindrical in shape, for example, with a circular base.

Alternative stimuli, here texts, are positioned on different azimuths of each roller 3a, 3b, 3c. For example, the roller 3a may have up to four distinct azimuths the words “le chat,” “la chatte,” “les chats” and “les chattes” [the cat/the cats] and the roller 3b may have the words “noir,” “noire,” “noirs” and “noires” [black].

In the example shown, the rotatable objects are cylinders of length about 5 times their diameter, with alternate words written on each of the four azimuths. In another embodiment, the rotatable objects may be discs with the alternate words written on one side.

According to yet another embodiment, the objects can be cylinders with a non-circular base, but having a constant diameter, such as Reuleaux figures.

The stimuli can be visual, tactile or even olfactory.

Texts are visual stimuli, while Braille writing can provide a tactile stimulus. It is conceivable to use olfactory stimuli to associate fragrances with other stimuli, olfactory or not.

The base 2 comprises a main longitudinal groove arranged to receive each of the rollers 3a, 3b, 3c successively along the longitudinal axis of the base, at least partially.

The rollers are received in the groove of the base so that their longitudinal axis is parallel to the longitudinal direction of the base.

The autocorrecting device comprises a groove 5 formed along the longitudinal axis arranged to receive successively, removably and at least partially, along the longitudinal direction of the base, each of the rollers when the generatrix of the cylinder is positioned parallel to the longitudinal direction of the base.

Placed in the base, the rollers 3b and 3c are free to rotate and their generatrixes are parallel to the longitudinal direction of the base.

In the example shown, the support is a base comprising a recess of a shape such that the cylinders are held in an approximately coaxial arrangement, and only one of the alternate words on each cylinder is highlighted. In another embodiment, the support holds cylinders side by side. In the case of a rotating object in the form of a disc, the support comprises a partial cover, so that only one of the alternate words is visible.

The roller 3a is referred to as master or determinant roller. The rollers 3b and 3c are referred to as determined rollers or determinant rollers. Of course, it is possible to have more than one master roller when the construction requires it.

The master roller 3a may be blocked in rotation by engaging one or more pegs 6 in notches 7 formed in the master roller 3a. The multiplicity of notches allows a choice between several orientations of the determinant roller 3b, each of the orientations corresponding to one or more words. The pegs 6 and notches 7 form a means for selecting an angular position of a determinant cylinder.

In the example shown, the rotational blocking device is mechanical. The rotational blocking device may also be made with magnets, or any other temporary fixing method such as the use of Velcro.

The device 1 comprises means for selecting an angular position of a first object relative to a second object, the selection means applying a resistive torque Cr between the first object and the second object.

The object selection means has a relative angular position referred to as “coupled” and a relative angular position referred to as “uncoupled.” In the coupled relative angular position, the resistive torque is greater than in the uncoupled relative angular position.

In the embodiment shown, the means for selecting the angular position is formed by one or more magnets 8, positioned at each end of a roller, forming a group of magnets. The group of magnets serves to block the relative rotation of two adjacent rollers so that their azimuths, taken with respect to a common reference, are equal.

In the example shown, the magnets 8, in particular, comprise the magnets 8a positioned on the roller 3a and the magnets 8b positioned on the roller 3b. The polarities of the magnets 8a and 8b are chosen so that an attraction force exists between the magnets 8a and 8b, which prevents selecting an azimuth of the roller 3b based on the azimuth of the roller 3a. The same is true for the rollers 3b and 3c.

In the example shown, the angular selection means comprises magnets positioned on the cylinders. This angular selection means may also be implemented by any other device that is in a minimum energy state when the objects are aligned.

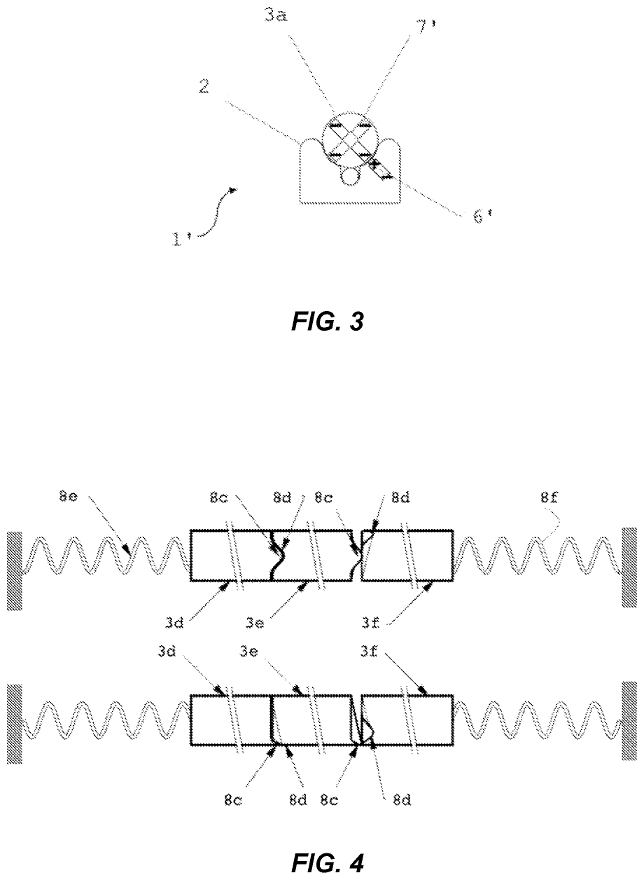

In the example shown in FIG. 3, it may be noted that the magnets 8a comprise a magnet 8a1 and 8a2, which are diametrically opposed. Of course, the cylinder 4 bears corresponding magnets 8b1 and 8b2 (not shown) cooperating with the magnets 8a1 and 8a2. Thus, if the magnets 8a1 and 8a2 are of opposite polarities, for example, positive and negative, respectively, the magnets 8b1 and 8b2 are also of opposite polarities, negative and positive, respectively.

It will be noted that the magnets 8a1 and 8a2 are on different radii of the cylinder with a circular base. More generally, they are at a different distance from an axis of rotation of the constant-diameter cylinder. This arrangement facilitates the rotation of the cylinder 4 relative to the cylinder 3 in positions where if the distances were identical, one would seek to bring two magnets closer that have identical polarities and that should face each other at a moment.

In the example shown, the means for selecting an angular position has a single coupled relative angular position.

According to other embodiments, the means for selecting an angular position has several coupled relative angular positions. This makes it possible, for an angular position of a determinant object, to match several angular positions of a determined object.

The base further comprises a housing for a pin arranged to receive a pin 9 in the longitudinal direction.

In the base, the rollers rest on the pin 9, such that a rotation of the pin causes a rotation of the rollers if the latter are free, the movement being transmitted by the friction between the pin 9 and the rollers. The relationship between this frictional force and the magnetic force between the magnets is such that the magnets 8 only prevent the relative rotation of one roller with respect to the other when the rollers are aligned.

According to the example shown, the pin 9 directly drives each of the rollers according to the principle of friction wheels.

The pin 9 and each of the rollers in fact form two cylindrical wheels. The two cylindrical wheels are in contact on a generatrix. The friction in contact with the two wheels makes it possible to transmit power from the pin 9 that forms the drive wheel to each of the rollers, each of the rollers forming the driven wheel. The transmitted power is therefore limited by friction.

The device 1 is provided with a drive means 10 for driving the pin 9 in rotation, a crank 10 in the example shown. The pin 9 may be retained in translation by a nut.

The drive means 10 has a predetermined object-driving torque M.

It is important to select the driving torque M and the resistive torque Cr so that the resistive torque Cr is higher than the driving torque M in the coupled angular position and lower than the driving torque M in any uncoupled angular position.

The resistive torque is calibrated so as to verify the relationship set out above.

The device 1 is further provided with partitions 11 arranged transversely to the longitudinal direction, in transverse grooves 12. Thus, the translation of the rollers 3a, 3b, 3c, on either side of the longitudinal direction, is stopped.

The selection means in a predetermined angular position prevent the rotation of a cylinder that is in a correctly spelled position with respect to a cylinder that itself is in a correctly spelled position.

When the user activates the crank, the words that are not tuned correctly, placed on determined cylinders, are rotated by the pin 9 until the correct face is visible, after which the incorrectly tuned word is no longer driven in rotation, due to the angular position selection means.

This machine allows users, mainly children, to manipulate and experiment with sentence construction without the help of an adult. The autocorrecting nature of the machine allows autonomous and deductive use.

FIG. 3 shows a second embodiment of a device 1′ for learning a grammar rule in a language according to the present disclosure, only described for its differences with respect to the first embodiment.

Instead of the means for selecting an angular position of a determinant cylinder formed by a peg and a notch, the means for selecting an angular position is formed by magnetic means 6′ and 7′ cooperating with one another.

To this end, according to the embodiment shown:
the magnetic means 6′ has a single magnet housed in the base of the device 1′ and has a positive polarity;
the magnetic means 7′ comprises several magnets housed radially in the roller 3a, all having a negative polarity.

These magnets should be several times stronger than the magnets 8.

FIG. 4 shows another embodiment of a means 8c, 8d for selecting an angular position of a first object relative to a second object.

More precisely, the figure shows three cylinders 3d, 3e, 3f.

In the upper figure, the two objects 3e and 3f are in an uncoupled position.

In the lower figure, the two objects 3e and 3f are in a coupled position.

In the two upper and lower figures, the two cylinders 3d and 3e are in a coupled position.

To this end, the selection means 8c and 8d determine complementary side surfaces for the cylinders 3d, 3e and 3f that can cooperate with one another according to a single relative angular position of two cylinders to minimize, if not cancel out, the space between the two cylinders.

The selection means further comprise the springs 8e and 8f, which work in compression and which are arranged to bring the objects together.

It is understood that as soon as the rotation of one of the cylinders, with respect to another adjacent cylinder previously blocked in rotation, assumes the angular position according to which the space can be minimized, the two cylinders are brought together under the action of the springs and can then no longer be driven in rotation, since the resistive torque Cr is then higher than the driving torque M.

It is also understood that if the device is oriented according to the earth's gravitational field, the selection means may not comprise the springs 8e and 8f, the gravitational field pressing the upper cylinder against the lower cylinder.

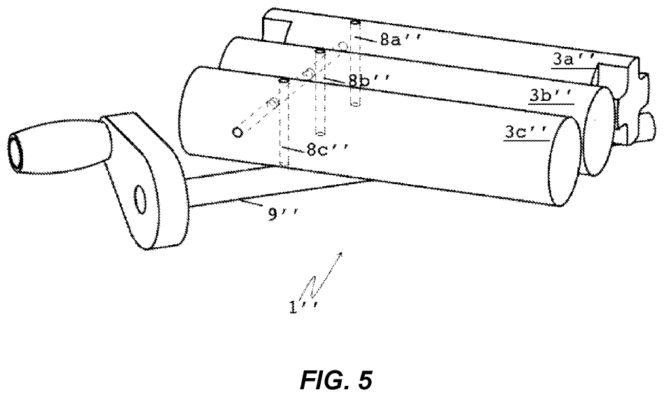

FIG. 5 shows a third embodiment of a device according to the present disclosure, only described for its differences with respect to the first embodiment, and able to implement certain features of the second embodiment.

The device comprises a plurality of objects that can be rotated, here three cylinders, or rollers, numbered 3a″, 3b″, 3c″. Unlike the first embodiment, the rollers are not arranged along the same axis of rotation, but side by side, along their generatrixes.

The roller 3a″ is referred to as master or determinant roller. The rollers 3b″ and 3c″ are referred to as determined or determinant rollers.

The master roller 3a″ can be blocked in rotation in several ways, as seen previously.

In the example shown, the position selection means comprise, in particular, the magnets 8a″ arranged along a transverse diameter of the roller 3a′ and the magnets 8b″, 8c″, respectively, each arranged on a transverse diameter of the roller 3b″, 3c″, respectively. The polarities of the magnets 8a″ and 8b″ are chosen so that an attraction force exists between the magnets 8a″ and 8b″, which prevents selecting an azimuth of the roller 3b″ according to the azimuth of the roller 3a″.

In the example shown, the means for selecting an angular position has a single coupled relative angular position.

The rollers rest on a pin 9″, so that rotating the pin causes a rotation of the rollers if the latter are free, the movement being transmitted by friction between the pin 9 and the rollers. The relationship between this frictional force and the magnetic force between the magnets is such that the magnets 8 only prevent the relative rotation of one roller with respect to the other when the rollers are aligned.

It is understood that it is sufficient for the axis of rotation 9″ not to be perpendicular to the longitudinal direction of the rollers to present a non-zero moment along the longitudinal directions of the rollers.

The various embodiments of this device according to the present disclosure allow the user, mainly children, to manipulate and experiment with the construction of sentences without the help of an adult. The autocorrecting nature of the machine allows autonomous and deductive use.

As will be readily understood, the present disclosure is not limited to the examples that have just been described, and numerous modifications may be made to these examples without departing from the scope of the invention as defined by the claims. In addition, the various features, forms, variants, and embodiments of the present disclosure can be grouped together in various combinations as long as they are not incompatible or mutually exclusive.

1. An autocorrecting device, comprising:
support;
at least two constant-diameter objects that can be rotated, at least one of the objects being referred to as determinant, the other at least one object being referred to as determined, each of the objects being provided with at least one stimulus associated with an angular position of the object;
a drive device configured to drive a pin in rotation to drive the objects in rotation, the drive device having a predetermined object-driving torque M;
a rotational blocking device configured to block a determinant object in a predetermined angular position; and
a selection device configured to select an angular position of a first object with respect to a second object, the selection device applying a resistive torque Cr between the first object and the second object, the two objects having a relative angular position referred to as a coupled position in which the resistive torque is greater than the driving torque M and a relative angular position referred to as uncoupled position in which the resistive torque is lower than the driving torque M.

2. The device of claim 1, wherein the pin directly drives each of the objects, the pin forming a friction wheel with each of the objects.

3. The device of claim 1, wherein the objects are cylinders with a circular base, and the support is a base having a longitudinal direction, the support including a groove formed along the longitudinal axis arranged to receive successively, removably and at least partially, along the longitudinal direction of the base, each of the cylinders when the generatrix of the cylinder is positioned parallel to the longitudinal direction of the base, the longitudinal groove being arranged to receive the cylinders mounted free in rotation, the drive device being driven in rotation by a crank.

4. The device of claim 1, wherein the selection device has several coupled relative angular positions.

5. The device of claim 1, further comprising several selection devices positioned at different distances from an axis of rotation of the object.

6. The device of claim 1, wherein the rotational blocking device comprises a peg and a notch.

7. The device of claim 1, wherein the rotational blocking device comprises complementary magnetic means.

8. The device of claim 1, wherein the selection device for selecting an angular position comprises magnetic means located and configured to cooperate with one another.

9. An autocorrecting method, comprising:
providing a device according to claim 1; and
selecting an angular position of the first object with respect to the second object by using the selection device.

10. The device of claim 2, wherein the objects are cylinders with a circular base, and the support is a base having a longitudinal direction, the support including a groove formed along the longitudinal axis arranged to receive successively, removably and at least partially, along the longitudinal direction of the base, each of the cylinders when the generatrix of the cylinder is positioned parallel to the longitudinal direction of the base, the longitudinal groove being arranged to receive the cylinders mounted free in rotation, the drive device being driven in rotation by a crank.

11. The device of claim 10, wherein the selection device has several coupled relative angular positions.

12. The device of claim 11, further comprising several selection devices positioned at different distances from an axis of rotation of the object.

13. The device of claim 12, wherein the rotational blocking device comprises a peg and a notch.

14. The device of claim 13, wherein the rotational blocking device comprises complementary magnetic means.

15. The device of claim 14, wherein the selection device for selecting an angular position comprises magnetic means located and configured to cooperate with one another.
